(19) United States
(12) Patent Application Publication
(10) Pub. No.: US 2013/0328798 A1
(43) Pub. Date: Dec. 12, 2013

(54) TOUCH PANEL WITH SAPPHIRE SUBSTRATE AND DISPLAY DEVICE

(71) Applicant: GA-LANE CHEN, Santa Clara, CA (US)

(72) Inventor: GA-LANE CHEN, Santa Clara, CA (US)

(21) Appl. No.: 13/675,984

(22) Filed: Nov. 13, 2012

(30) Foreign Application Priority Data
Jun. 6, 2012 (TW) 101120250

(51) Int. Cl. H01H 1/027; G06F 3/041

(52) U.S. Cl. CPC H01H 1/027; G06F 3/041; B82Y 15/00
USPC 345/173; 200/267; 977/956

(57) ABSTRACT

A touch panel includes a substrate, a transparent conducting layer, and an antireflection film. The substrate is made of sapphire, and includes a first surface and a second surface opposite to the first surface. The transparent conducting layer is covered on the first surface and is configured for detecting a touch operation thereon. The antireflection film is coated on the second surface and is configured for increasing the transmissivity of the substrate in relation to visual light.

### BACKGROUND

1. Technical Field

The present disclosure relates to touch panels, and particularly, to a touch panel with sapphire substrate and a display device including the touch panel.

2. Description of Related Art

Touch panels generally include a substrate and a transparent conducting layer covered on the substrate. In order to improve hardness and strength of the touch panel, the substrate is processed by a physical or chemical enhanced treatment. However, the process of the enhanced treatment is often complex, inefficient, and costly, with unsatisfactory results.

Therefore, it is desirable to provide a touch panel and a display device, which can overcome the limitations described.

### BRIEF DESCRIPTION OF THE DRAWINGS

FIG. 1 is a cross-sectional schematic view of a touch panel in accordance with an exemplary embodiment.

FIG. 2 is a cross-sectional schematic view of a display device using the touch panel of FIG. 1.

### DETAILED DESCRIPTION

Embodiments of the disclosure will be described with reference to the drawings.

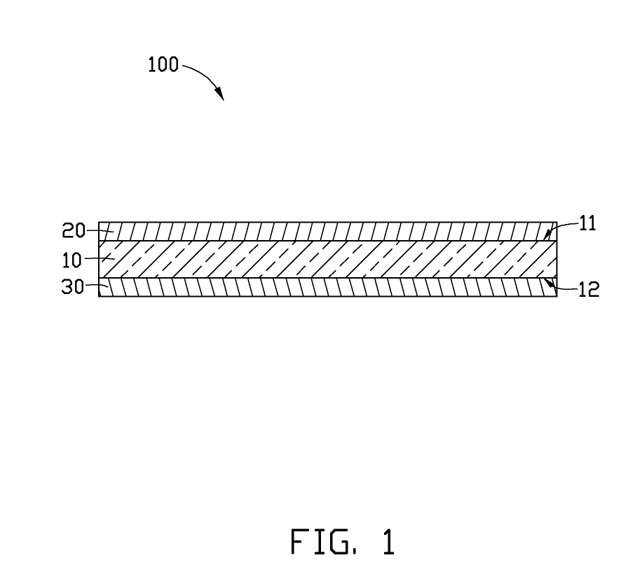

Referring to FIG. 1, a touch panel 100, according to an exemplary embodiment is shown. The touch panel 100 includes a substrate 10, a transparent conducting layer 20, and an antireflection film 30.

The substrate 10 is plate shaped and is made of sapphire. Sapphire is a gemstone variety of the mineral corundum, and has a hexagonal crystal structure. The main chemical component of sapphire is aluminum oxide, and the refractive index of the sapphire is from about 1.76 to about 1.78. The growth direction of the sapphire is a-axis (11 2̅0), c-axis (0001), m-axis (10 1̅0). A transmissivity of the substrate 10 at visual wavelengths from about 420 nm to about 700 nm is lower than 86%. The substrate 10 includes a first surface 11 and a second surface 12 opposite to the first surface 11.

In this embodiment, the process of manufacturing the sapphire is thin film molding. The sapphire ingot is cut into the chip shaped sapphire by a laser blade, and the chip sapphire is cut into the substrate 10 according to the size of the touch panel 100.

The transparent conducting layer 20 is configured for detecting a touch operation, and outputs a detecting signal corresponding to the touch operation. The transparent conducting layer 20 covers on the first surface 11 of the substrate 10. The transparent conducting layer 20 is a carbon nanotube film, and the carbon nanotube film includes a number of carbon nanotubes equidistantly arrayed along the same direction. As the carbon nanotubes of the transparent conducting layer 20 are equidistantly arrayed on the substrate 10, the resistance distribution and the light transmission of the transparent conducting layer 20 are uniform, improving resolution and accuracy of the touch panel 100.

In this embodiment, the carbon nanotube film 20 is deposited on a silicon substrate by a chemical vapor deposition. Then, the carbon nanotube film is peeled off the silicon. At last, the carbon nanotube film 20 is covered on the substrate 10.

The antireflection film 30 increases the transmissivity of the substrate 10 in relation to visual light, and is coated on the second surface 12 of the substrate 10 by a sputter method or an evaporation method. The antireflection film 30 includes a number of high refraction index layers and a number of low refraction index layers alternately stacked on the substrate 10.

The film structure of the antireflection film 30 is (xHyL)^{η}, 4≦η≦8, 1<x<2, 1<y<2; where η is an integer. H represents a quarter of optical thickness of a central wavelength of the high refraction index layers, L represents a quarter of optical thickness of the central wavelength of the low refraction index layers. xH represents x times a quarter of optical thickness of the central wavelength of the high refraction index layers, yL represents y times a quarter of optical thickness of the central wavelength of the low refraction index layers, and η represents a number of cycles of the low refraction index layer and the high refraction index layer. In this embodiment, the central wavelength is a middle of a wavelength range, which is transmitted by the antireflection film 30.

The material of the high refraction index layers is titanium dioxide (TiO₂), and the refraction index of the high refraction index layers is about 2.705. The material of the low refraction index layers is silicon dioxide (SiO₂), and the refraction index of the low refraction index layers is about 1.499. The materials of the high and low refraction index layers can be other materials.

In other embodiments, hardness of the touch panel 100 is from about 1500 Kg/mm² to about 2000 Kg/mm², yield strength of the touch panel 100 is from about 300 MPa to about 400 MPa, compressive strength of the touch panel 100 is about 2 GPa, temperature range is from about −40° C. to about 2000° C. The touch panel 100 can bear high voltage and high frequency, and the transmissivity of touch panel 100 at visual wavelengths from about 420 nm to about 700 nm is from about 90% to about 99.5%.

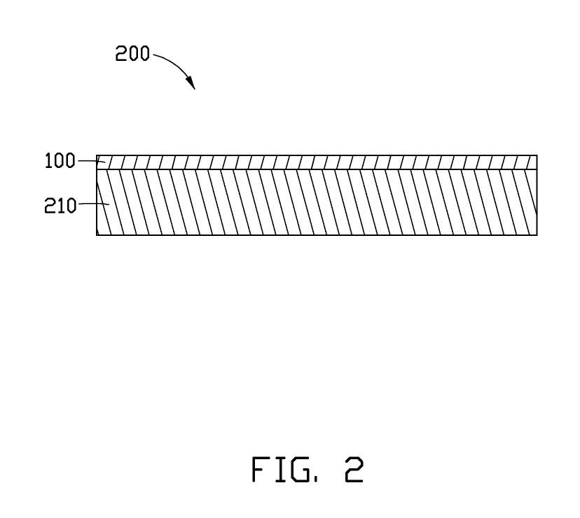

Referring to FIG. 2, a display device 200, according to an exemplary embodiment, includes the touch panel 100 and a display 210. The touch panel 100 covers on the display 210. The display 210 displays different images according to the detecting signals outputting from the touch panel 100. First, as hardness and strength of the touch panel 100 are greater than a mother glass, the touch panel 100 can protect the display 210 from being damaged. Second, as the touch panel 100 can bear high voltage and high frequency, the display device 200 can work in an industrial environment. Third, as the transmissivity of touch panel 100 at visual wavelengths is from about 90% to about 99.5%, resolution and definition of the display device 200 can be ensured.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A touch panel, comprising:
a substrate made of sapphire, the substrate comprising a first surface and a second surface opposite to the first surface;
a transparent conducting layer covered on the first surface and configured for detecting a touch operation thereon; and
an antireflection film coated on the second surface and configured for increasing the transmissivity of the substrate in relation to visual light.

2. The touch panel of claim 1, wherein the transparent conducting layer is a carbon nanotube film, and the carbon nanotube film comprises a plurality of carbon nanotubes arrayed along the same direction.

3. The touch panel of claim 1, wherein a refractive index of the sapphire is from about 1.76 to about 1.78, and the growth direction of the sapphire is a-axis (11 2̅0), c-axis (0001), m-axis (10 1̅0).

4. The touch panel of claim 3, wherein the antireflection film is represented by (xHyL)^{η}, 4≦η≦8, 1<x<2, 1<y<2; where η is an integer, H represents a quarter of optical thickness of a central wavelength of the high refraction index layers, L represents a quarter of optical thickness of the central wavelength of the low refraction index layers, xH represents x times a quarter of optical thickness of the central wavelength of the high refraction index layers, yL represents y times a quarter of optical thickness of the central wavelength of the low refraction index layers, and η represents a number of cycles of the low refraction index layer and the high refraction index layer.

5. The touch panel of claim 4, wherein the material of the high refraction index layers is titanium dioxide, and the refraction index of the high refraction index layers is about 2.705, the material of the low refraction index layers is silicon dioxide, and the refraction index of the low refraction index layers is about 1.499.

6. A display device, comprising:
a display; and
a touch panel covered on the display, the touch panel comprising:
a substrate made of sapphire, the substrate comprising a first surface and a second surface opposite to the first surface;
a transparent conducting layer covered on the first surface and configured for detecting a touch operation thereon; and
an antireflection film coated on the second surface and configured for increasing the transmissivity of the substrate in relation to visual light.

7. The display device of claim 6, wherein the transparent conducting layer is a carbon nanotube film, and the carbon nanotube film comprises a plurality of carbon nanotubes arrayed along the same direction.

8. The display device of claim 6, wherein a refractive index of the sapphire is from about 1.76 to about 1.78, and the growth direction of the sapphire is a-axis (11 2̅0), c-axis (0001), m-axis (10 1̅0).

9. The display device of claim 6, wherein the antireflection film is represented by (xHyL)^{η}, 4≦η≦8, 1<x<2, 1<y<2; where η is an integer, H represents a quarter of optical thickness of a central wavelength of the high refraction index layers, L represents a quarter of optical thickness of the central wavelength of the low refraction index layers, xH represents x times a quarter of optical thickness of the central wavelength of the high refraction index layers, yL represents y times a quarter of optical thickness of the central wavelength of the low refraction index layers, and η represents a number of cycles of the low refraction index layer and the high refraction index layer.

10. The display device of claim 9, wherein the material of the high refraction index layers is titanium dioxide, and the refraction index of the high refraction index layers is about 2.705, the material of the low refraction index layers is silicon dioxide, and the refraction index of the low refraction index layers is about 1.499.
